(19) United States
(12) Patent Application Publication
(10) Pub. No.: US 2022/0203454 A1
(43) Pub. Date: Jun. 30, 2022

(54) MANUFACTURING METHOD WITH ADDITIVE COMPONENT PRODUCTION AND POST-PROCESSING

(71) Applicant: OWL AM ADDITIVE MANUFACTURING GMBH, Leopoldshöhe (DE)

(72) Inventors: Raphael HOFFMANN, Hamburg (DE); Markus HOFFMANN, Bielefeld (DE)

(21) Appl. No.: 17/600,762

(22) PCT Filed: Mar. 31, 2020
(86) PCT No.: PCT/EP2020/059152

§ 371 Date: Oct. 1, 2021

(30) Foreign Application Priority Data
Apr. 2, 2019 (EP) 19166901.9

(51) Int. Cl. B22F 10/80; B33Y 10/00; B33Y 40/20; B33Y 50/00; B22F 10/28; B22F 3/15; B22F 10/64; B22F 10/66

(52) U.S. Cl. CPC B22F 10/80; B33Y 10/00; B33Y 40/20; B22F 10/66; B22F 10/28; B22F 3/15; B22F 10/64; B33Y 50/00

(57) ABSTRACT

The invention relates to a method of manufacturing components, comprising the steps of: a) manufacturing a component blank in an additive manufacturing process, comprising: a1) determining component regions of the component blank to be cured in an electronic planning process and generating a component blank data set defining the component regions to be cured, a2) arranging a raw material and selectively curing and joining the raw material in the component regions to be cured on the basis of the component blank data set to form the component blank, wherein the curing and joining of the raw material on the basis of the component blank data set is carried out such, that the component blank has a component blank density which is less than 99.5% of the density theoretically achievable with the raw material, b) compacting and solidifying the component blank to form a component in a hot isostatic pressing process, in which the component blank is heated in a furnace chamber to a temperature below the melting temperature of the raw material and is pressed by generating an overpressure in the furnace chamber by means of a furnace chamber pressure of at least 50 bar.

The invention relates to a method for manufacturing components in an additive manufacturing process.

Additive manufacturing processes are production processes in which a component is built up in a data-controlled manner by generating product sections point-by-point, line-by-line or region-by-region by joining these component sections together during their manufacture. Additive manufacturing processes are characterized by the fact that the product is built up point-by-point, line-by-line or layer-by-layer and material is added to the product during the manufacturing process. In contrast, in mechanical manufacturing processes such as milling, turning or eroding, the product is manufactured from a semi-finished product by removing material.

Additive manufacturing processes within the meaning of the invention can be classified in different ways. A first classification is according to the raw material used, which may for example be powder or liquid, individual additive manufacturing processes also use solid semifinished products such as fibres or rods which are melted during the manufacturing process in order to be processed. Typically, the raw material is in a flowable state during the additive manufacturing process and may be brought to the selective location of the product in this flowable state to be cured, for example by a chemical reaction, melting and solidification. Another classification groups the additive manufacturing processes according to the systematics of the build-up process. Here, for example, layer-by-layer manufacturing processes are in use, in which a liquid or powdery material is selectively cured as a layer in the layer plane and bonded to the underlying layer, and in this way the product is manufactured in a repetitive layer-building process. In these methods, the material may first be applied as a complete layer and then portions of that layer may be sintered or melted selectively by the application of energy (e.g., by laser or electron beam) to thereby selectively effect curing and bonding. A first material component may also first be applied as a layer, and then a second material component may be selectively applied in portions of this layer. This second material component can lead directly to curing and bonding, or this can be done by subsequent energy action or chemical action.

Processes encompassed by the invention are known conceptually, for example, as selective laser melting, selective laser sintering, selective heat sintering, binder jetting, electron beam melting, fused deposition modeling, wax deposition modeling, contour crafting, metal powder application, electron beam welding, stereolithography, digital light processing, liquid composite molding, laminated object modeling, or 3D printing. Some of the processes are known by names or proprietary marks such as LENS, DMLS, LaserCusing®, XJet®3D Printing, Polyamide Casting, and as Multi-Jet Modeling.

Additive manufacturing processes can also apply the material in spots or droplets, for example 3D printing processes in which a liquid or liquefied material is dispensed from a print head and the print head selectively moves to the product regions predetermined by the data control to build up the product. Here, the material may be in liquid initial form or may be in the form of wire, strand or the like and melted prior to application. According to this description and the appended claims, a generative or additive manufacturing process is to be understood in particular as any additive manufacturing process defined in ASTM F2792-10, including any process of material bonding for manufacturing objects from 3D model data, in particular 3D printing, fused deposition modeling, selective laser sintering or melting and stereolithography.

Additive manufacturing processes have been used industrially since the 1990s. Initial forms of use included prototype construction, in which additive manufacturing processes made it possible to produce an illustrative piece of a product in order to be able to visually inspect it and, if necessary, examine it in installation situations. This production of demonstration pieces was further developed into prototype construction, in which a product with already approximated mechanical properties of the original product was produced using additive manufacturing in order to be able to conduct mechanical tests thereon. Through constant further development of the additive manufacturing process according to the different additive manufacturing methods, these have evolved in such a way that it is also possible to manufacture individual products with properties that are sufficient for the end user. This further development is possible in particular through high-resolution selective manufacturing, which produces a density of more than 99% in the additive manufacturing process through the appropriate choice of raw materials and manufacturing parameters. The high-density components produced additively in this way have such low residual porosity that the mechanical properties are qualitatively reliable and at a high level, and are comparable with or even exceed the properties of traditional manufacturing processes such as casting or mechanical machining.

In individual applications, for example in medical technology and aerospace technology, individual products and products in small series are already being produced using additive manufacturing processes. One problem that stands in the way of additive manufacturing in use for smaller series or medium and large quantities of products is the duration of the manufacturing process. Due to the usually pointwise or layerwise structure and the high resolution and manufacturing parameters required for the desired high-quality mechanical properties, the manufacturing time for additive manufacturing processes is longer than the manufacturing time for conventional manufacturing processes such as casting and machining. In order to open up additive manufacturing processes to smaller, medium and large series, different approaches are being pursued. For example, the parallel build-up of several products on a substrate plate is one approach to increasing manufacturing efficiency, while other proposals work with continuous processes in which products are additively manufactured on an endless conveyor belt using an inclined layer build-up or point-by-point manufacturing processes. These additive manufacturing technologies have not yet reached a level of competitiveness that has led to a breakthrough compared to conventional manufacturing processes.

It is the task of the invention to further develop an additive manufacturing process in order to make it possible to produce at least medium quantities in an economically efficient manner.

This task is solved according to the invention with a method for manufacturing components, comprising the steps:
a) Producing a component blank in an additive manufacturing process, comprising:
a1) Determining, in an electronic planning process, component regions of the component blank which are to be cured and generating a component blank data set defining said component regions to be cured.
a2) dispensing a raw material and selectively curing and joining the raw material in said component regions to be cured based on the component blank data set of said component blank,
   wherein the curing and joining of the raw material is performed using the component blank data set such that the component blank has a component blank density which is less than 99.5% of the density theoretically achievable with the raw material,
b) compacting and solidifying the component blank to form a component in a hot isostatic pressing process, in which the component blank is heated in a furnace chamber to a temperature below the melting temperature of the raw material and is pressed by generating an overpressure in the furnace chamber by means of a furnace chamber pressure of at least 50 bar.

According to the invention, the product is first manufactured in an additive manufacturing process, whereby in principle all systems for additive manufacturing may be considered for the invention. However, according to the invention, the additive manufacturing process is not carried out with such parameters that the outgoing product of the additive manufacturing process is already a product that can be sufficiently loaded mechanically. Instead, the parameters of the additive manufacturing process are modified with the aim of considerably shortening the additive manufacturing process in terms of time, accepting that the product thus manufactured achieves a density of less than 99.5%. In this context, density is understood to mean that a component manufactured without any pores from the raw material has a theoretical density of 100% and that this density is always reduced in practice due to pores in the material. According to the invention, the additive manufacturing process according to the invention produces a density which is below the density realized today with additive manufacturing processes. In particular, the density may also be less than 99%, less than 98% or less than 97%. Furthermore, the manufacturing parameters can also be adjusted so that the density of the component blank is even lower, for example lower than 95%, lower than 90%, lower than 80%, lower than 50% or lower than 20%. The density is to be understood as the density of the component blank averaged over the entire volume. The disadvantage of a lower mechanical load-bearing capacity of the additively manufactured component blank resulting from the reduced density is offset by the advantage of a significantly shortened production time in the additive manufacturing process.

According to the invention, the additive manufacturing process is followed by a compacting and solidifying process, which is carried out in a hot isostatic pressing process. Hot isostatic pressing processes are known as production processes for the consolidation of so-called green bodies, i.e. geometrically pre-produced intermediate products which often still contain a binder material. According to the invention, the hot isostatic pressing process is used for compacting and solidifying the component blank resulting from the additive manufacturing process. In the hot isostatic pressing process, the product is placed in a pressure-tight furnace chamber where it is compacted and solidified under the action of an elevated temperature and an elevated pressure. Typically, a pressure of at least 10 bar or at least 50 bar is generated in the furnace chamber, which can often be more than 100 bar, more than 200 bar, more than 500 bar or more than 1000 bar.

Further, a temperature is set in the furnace chamber that is below the melting temperature of the raw material so that, physically, a sintering process occurs. For example, the temperature in the furnace chamber may be set at less than 60%, less than 70%, less than 80%, or less than 90% of the melting temperature of the respective material. In the hot isostatic pressing process, the component blanks are subjected to the elevated temperature and pressure for a pressing time of typically more than half an hour, more than an hour, or more than 2.5 hours or more than 5 hours, and are thereby compacted and solidified. As a result of this compaction and solidification in the hot isostatic pressing process, the density of the component blank is increased and may be increased to above 99% and, depending on the raw material and component blank density, may reach nearly the ideal value of 100% density after the additive manufacturing process, for example above 99.7 or above 99.9%.

According to the invention, both the time duration of the manufacturing process as a whole is reduced by significantly shortening the production in the additive manufacturing process and by using a hot isostatic pressing process as a post-treatment process. The reduction in time is achieved even though an additional process step is performed, because a large number of products can be produced, or treated, in parallel both in the additive manufacturing process and, even more, in the hot isostatic pressing process. Furthermore, with the process according to the invention, a high and reproducible component quality can be achieved, since components with a high density and high mechanical load capacity can be reliably produced by the manufacturing sequence. This enables component production in small and medium series with a very low reject rate and very high reliability of the mechanical properties.

According to a first preferred embodiment, it is foreseen in the method according to the invention that generating the component blank data set in step a1) comprises the steps of:
determining an outer geometry of the component blank
defining an envelope region and a core region of the component blank, the envelope region enclosing the core region,
determining a first value of a first manufacturing parameter for the core region, and
determining a second value of said first manufacturing parameter for the envelope region, the second value being different from the first value,

and wherein the selective curing and joining of the raw material in step a2)
is performed in the core region using the first value of the first manufacturing parameter and hereby generates a first density in the core region,
is performed in the envelope region using the second value of the first manufacturing parameter and hereby generates a second density in the envelope region which is higher than the first density.

According to this embodiment, the component is divided into an envelope region and a core region during electronically supported production planning. Both the envelope region and the core region are part of the product itself and together form the component blank. The envelope region is a thin wrapping layer that runs along and within the outer contour of the component. When generating the component blank data set, this envelope region may be defined and extends inwardly from the outer contour of the component, for example, less than 0.5, less than 1 or less than 2 mm. The envelope region encloses the core region, which consequently constitutes the main volume fraction of the component. This enclosure may be complete, such that the envelope region serves as a pressure-transmitting, tight cladding in the HIP process. The enclosure may also be partial, so that the envelope region does not constitute a completely pressure-tight envelope, but, for example, still allows pressure to pass through to a region located within the core region.

The determination of the envelope region and the core region of the component blank may be performed during the electronic design process in which the component blank data set is generated, by manual input of a user, or may be automated according to predetermined criteria. Consequently, the component blank data set includes a geometric definition of the envelope region and the core region. The component blank data set may further comprise manufacturing parameters for the envelope region and manufacturing parameters for the core region, but these may also be stored in a separate manufacturing data set separate from or together with the geometric data of the product, the core region and the envelope region. During selective curing and joining of the raw material, different manufacturing parameters are used in the additive manufacturing process for the envelope region and for the core region. In the envelope region, manufacturing parameters are used which produce a higher density than in the core region. The result of the additive manufacturing process modified in this way is a component blank which has a dense outer layer and, in contrast, a less dense, open or closed porous inner material volume which is enveloped by this dense layer. The component blank produced in this way can be manufactured with a very short production time using the additive manufacturing process, since the manufacturing parameters of the core region can be selected in such a way that this can be manufactured with a very short production time. For the cladding region only, a manufacturing method is used with parameters that produce a high density, in particular a gas-tightness of the cladding region. The entire component blank has an average density averaged from the envelope region and core region of less than 97%. Due to the dense cladding region, the component blank produced in this way can be subjected directly to a hot isostatic pressing process. The dense envelope region provides the dense enclosure of the volume to be compacted and consolidated in the core region that is necessary for effective hot isostatic pressing.

Still further, it is preferred that in the method according to the invention the generating of the component blank dataset comprises:
determining an outer geometry of the component blank
defining a first envelope region and a core region of the component blank, the first envelope region partially or completely enclosing the core region,
defining at least one second envelope region enclosing a partial volume of the core region, the second envelope region lying within the first envelope region,
determining a first value of a first manufacturing parameter for the core region,
determining a second value of said first manufacturing parameter for the first envelope region, the second value being different from the first value,
determining a third value of said first manufacturing parameter for the partial volume, the third value preferably being the same as the first value, and
optionally determining a fourth value of said first manufacturing parameter for the second envelope region, the fourth value preferably being the same as the second value,
and the selective curing and joining of the raw material
is performed in the core region using the first value of the first manufacturing parameter and generates a first density in the core region,
is performed in the first envelope region using the second value of the first manufacturing parameter and produces a second density in the first envelope region which is higher than the first density,
is performed in the partial volume using the third value of the first manufacturing parameter and produces a third density in the partial volume which is preferably identical to the first density, and
optionally is performed in the second envelope region using the fourth value of the first manufacturing parameter and produces a fourth density in the second envelope region that is preferably identical to the second density.

According to this further embodiment, as in the first preferred embodiment, an outer envelope region and a core region are defined in the component blank. This outer, first envelope region encloses the entire core region of the product. Within this core region, one or more partial volumes are enveloped by an additional second envelope region. This second envelope region may extend completely spaced apart from the first envelope region, and consequently define and enclose an isolated individual volume within the core region. The second envelope region may also be line or point contiguous with the first envelope region, thereby enclosing a sub-volume partially enclosed by the first envelope region and partially enclosed by the second envelope region. By using this first and second envelope region, a material structure of the component blank and of the component produced therefrom by the hot isostatic pressing process is achieved which is adapted to the load and the resulting stress of the component. The enclosure of the partial volume by the second envelope region produces an additional favourable compression and pressing and makes it possible to achieve a different density in the partial volume to the remaining core region of the product.

Alternatively, it is preferred that the method according to the invention comprises generating the component blank data set:
Determination of an outer geometry of the component blank
defining a first envelope region and a core region of the component blank, the first envelope region partially or completely enclosing the core region,
Determining a partial volume of the core region,
Determining a first value of a first manufacturing parameter for the core region,
determining a second value of the first manufacturing parameter for the first envelope region, the second value being different from the first value, and
determining a third value of the first manufacturing parameter for the partial volume, the third value preferably being the same as the first value, and

and the selective curing and joining of the raw material
in the core region is performed with the first value of the first manufacturing parameter and generates a first material property in the core region,
in the first envelope region is performed with the second value of the first manufacturing parameter and produces a second material property in the first envelope region which is different from the first material property, and
in the partial volume is performed with the third value of the first manufacturing parameter and produces a third material property in the partial volume which is different from the first material property.

Thereby, it is particularly preferred if the third value of the first manufacturing parameter defines that no raw material is arranged in the partial volume during the additive manufacturing process, or the raw material is arranged in the partial volume during the additive manufacturing process and is removed again in a subsequent step. According to this embodiment, a hollow, i.e. not filled with material, partial volume is created, in which consequently a gas or ambient air is arranged. On the one hand, depending on the additive manufacturing process used, this can be achieved by defining by the third value of the first manufacturing parameter that no raw material is arranged in the partial volume, so that immediately during the additive manufacturing process the partial volume remains unfilled. This is particularly possible in additive manufacturing processes that arrange and cure and bond the material in a point-by-point manner. Alternatively, particularly in additive manufacturing processes that apply a powder bed, the third value of the first manufacturing parameter may define that the material arranged in the partial volume is not cured and bonded, so that it still remains in unconsolidated form, i.e. as a powder layer or liquid. The material from the partial volume may then be removed in a subsequent step, resulting in the hollow partial volume. This removal step may occur immediately after the layer application and selective curing of the layer, or may occur after several successive layer applications and their respective selective curing, for example in the case of a manufacturing step which has not yet closed the second envelope region around the partial volume, but which would do so in the next manufacturing step. The hollow partial volume thus obtained may be maintained in the subsequent HIP process if it is connected to the surrounding environment, i.e. has at least one connecting channel to the surrounding envelope and through it connects the partial volume to the oven chamber pressure in the oven chamber of the HIP oven.

Still further, it is preferred that the fourth value of the first manufacturing parameter defines that a second raw material is disposed in the partial volume during the additive manufacturing process that is different from the raw material in the core region. According to this embodiment, a second raw material is arranged in the partial volume that is different from the raw material in the core region. In this way, a component blank can be produced which has different material regions. In particular, this can be done in spot-applied manufacturing processes by direct selective application of different materials. The different raw materials can subsequently be compacted and consolidated together in the HIP process.

Furthermore, it is preferred if the third value of the first manufacturing parameter defines that a different material is arranged in the partial volume than in the core region. On the one hand, this can be done in such a way that, in the course of the material application, a first raw material is arranged directly in the core region and a second raw material is arranged in the partial volume, if the process flow of the additive manufacturing method permits this, such as in 3D printing methods.

Alternatively, this may be done by placing the raw material in the core region and placing the raw material in the partial volume during the additive manufacturing process, removing it in a subsequent step, and filling the partial volume with a second raw material which is different from the raw material in the core region. According to this embodiment, the partial volume is first filled with the raw material, but this is subsequently removed, as previously described, in order to produce a hollow partial volume. The hollow partial volume thus produced is then filled with a second raw material which is different from the first raw material. This may again be done in layers, or may be done in total after applying multiple layers of the raw material. The filling of the partial volume with the second raw material may also be carried out in layers, or the entire partial volume may be filled with the second raw material in one step or in two or more steps. Preferably, this filling is carried out before the second envelope region completely or partially closes the partial volume in order to obtain good accessibility.

In this regard, it is particularly preferred that during or after the filling of the second raw material into the partial volume a compression of the second raw material takes place in the partial volume, in particular by means of a vibrating process of the second raw material. Such compression measures, such as a vibrating process, may lead to a sufficient compaction of the second raw material in the partial volume, which in the subsequent HIP process leads to a mechanically loadable, dense component region also in the partial volume. Compaction may occur overall after the partial volume has been filled, and after compaction has occurred, the partial volume may also be refilled to fill any regions of the partial volume that have become vacant as a result of compaction. The compaction and refilling of second raw material into the partial volume can take place in two, three or more successive steps in order to achieve the most complete and dense filling of the partial volume with the second raw material.

In the aforementioned preferred embodiments with a partial volume within the core region, it is further particularly preferred if the component regions to be cured defined in step a1) comprise a pressure equalization channel extending from the first envelope region to the second envelope region and connecting the partial volume to the environment of the component blank for fluid pressure transfer. Such a pressure equalization channel causes a direct pressure connection between the partial volume and the environment of the component blank, so that during the HIP process the pressure prevailing in the partial volume is the pressure applied in the furnace chamber of the HIP process. In this way, the partial volume can remain as a hollow volume and is not deformed or even completely reduced by the HIP process. The pressure equalization channel may be used primarily to obtain a hollow partial volume, but in certain applications may also be used to obtain a second feedstock material not disposed in the partial volume during the HIP process in an uncompacted and unsolidified state.

According to a further preferred embodiment, it is provided that
said manufacturing parameter is a travel speed of a collimated electron beam and the first value is smaller than the second value or the third value is smaller than the fourth value, or
said manufacturing parameter is a radiation intensity of a collimated electron beam and the first value is greater than the second value or the third value is greater than the fourth value, or
said manufacturing parameter is a path spacing between two adjacent raster paths of a collimated electron beam and the first value is smaller than the second value, or the third value is smaller than the fourth value, or
   said manufacturing parameter is a duration of an energy impact on the raw material leading to curing and bonding, and the first value is greater than the second value or the third value is greater than the fourth value, or
   said manufacturing parameter is a layer thickness or a drop size when applying the raw material, and the first value is smaller than the second value, or the third value is smaller than the fourth value, or
said manufacturing parameter is a material definition and the first value, the second value and/or the third value each define different raw materials.

To achieve the different densities or material properties in the core region and the cladding region, or in the partial volume and the first or second cladding region, a single or multiple manufacturing parameters of the additive manufacturing process may be changed. In principle, the travel speed of an energy beam such as an electromagnetic beam, for example a laser beam, with which the regions to be selectively cured are irradiated and thereby melted and subsequently solidified, or solidified by photopolymerization, can be increased in the core region or partial volume relative to the cladding region. The increased travel speed significantly reduces the production time in the additive manufacturing process. Alternatively or additionally, the radiation intensity of such a beam may be reduced, wherein radiation intensity means radiation energy per region. Thus, the focusing or collimation of such an electron beam may be reduced and thereby a larger region can be covered by the electron beam. This also makes it possible to cover a certain region with the electron beam in a shorter time, thereby reducing the production time. Furthermore, a path spacing between adjacent paths which an electron beam scans can be increased in the core region or partial volume in comparison to the envelope region. In this way, edge regions of the path can be irradiated with lower energy or even the path spacing can be selected so large that uncured raw material remains between two paths. By varying the parameters in this way, an region in the core region/partial volume can be covered by the electron beam in a shorter time and the overall production time can also be reduced as a result. Furthermore, the energy input in the core region/subvolume can be shortened or no energy input at all can take place in order to reduce the curing time in the core region/subvolume or to avoid curing completely. In particular, this can be achieved by shortening the duration of energy application. Still further, the layer thickness or droplet size can be increased when applying the raw material in the core region/sub-volume. This may result in less overall curing in the core region/subvolume when the energy exposure in the core region and cladding region are the same. For example, a greater layer thickness can be produced in the core region/sub-volume by curing and bonding by the application of energy only after every second, third or after several layer applications, whereas curing and bonding takes place in the cladding region after every layer application.
Still further, it is preferred that generating of the component blank data set in step a1) comprises:
   determining an outer geometry of the component blank
   defining an envelope region and a core region of the component blank, the envelope region completely or partially enclosing the core region,
and wherein during the selective curing and joining of the raw material in step a2)
the raw material in the envelope region undergoes processing leading to curing and joining, and
the raw material in the core region does not undergo any processing leading to curing and joining, and
compacting and consolidating the component blank in step b) comprises:
curing and joining of the raw material in the core region.

According to this embodiment, the envelope region is cured and joined during the additive manufacturing process, thereby forming a cooling structure that defines and stabilizes the component geometry. In contrast, no curing and joining takes place in the core region or at least partial regions of the core region, so that the raw material in the core region or partial regions of the core region remains unchanged during the additive manufacturing process. In the downstream hot isostatic pressing process, the core region or the uncured partial regions therein are then compacted and solidified. This can be done effectively in the hot isostatic pressing process due to the enveloping structure of the enveloping region, as this encloses the uncured core region in a gas-tight manner. With this modification of the manufacturing process, the manufacturing time in the additive manufacturing process can be significantly reduced.

According to a preferred embodiment, it is further provided that during the assembly of the component blank with a first and second envelope region, a core region and a partial volume in step a1)
one of the two values selected from the first and the third value defines that the raw material does not undergo a processing leading to curing and joining, and
the other of the first and third values defines that the raw material undergoes processing leading to curing and joining, and

during the selective curing and joining of the raw material in step a2)
the raw material in the region which is cured and joined with one of the two values does not undergo any processing leading to curing and joining, and
the raw material in the region to be cured and joined with the other of the two values undergoes processing leading to curing and joining, and

compacting and consolidating the component blank in step b) comprises:
curing and joining of the raw material in the region that is cured and joined with one of the two values.

According to this embodiment, a core region and a partial volume or partial volumes in the core region are defined during the creation of the component blank data set, and manufacturing parameters are assigned in this core region and partial volume(s) which, in subsequent additive manufacturing processes, result in only the core region or only the partial volume(s), resp. the partial volumes are subjected to hardening and joining, whereas the corresponding other region (i.e. the partial volume(s) or the core region) is not subjected to such hardening and joining and the raw material consequently remains unchanged here. The result is then a component blank which has a hardened and joined envelope and, within the envelope, has uncured volume regions and hardened volume regions, the hardened volume regions typically having a lower density than the envelope region. Again, the component blank so produced may be compacted and consolidated in the downstream hot isostatic pressing process to produce a final component density with high mechanical load capacity.

According to a further preferred embodiment, it is provided that the raw material has such a temperature resistance, and the hot isostatic pressing process is performed with such process parameters that the weight of the component blank does not change during the hot isostatic pressing process. According to this embodiment, all of the material formed into the component blank during the additive manufacturing process remains, and no material is removed from the component blank by transition to the gaseous phase during the hot isostatic pressing process. The component weight of the product obtained after the hot isostatic pressing process therefore corresponds to the component weight of the component blank which is inserted into the furnace chamber of the hot isostatic pressing furnace after the additive manufacturing process.

According to a further preferred embodiment, it is provided that a material which behaves homogeneously during curing and joining is processed as the raw material, in particular a powder material which comprises powder particles, all the powder particles having a matching melting temperature. In this context, a homogeneously behaving material is to be understood as a liquid, a powder, a solid raw material or the like, in which the material of which the subsequent component is composed is contained, and which is cured and joined during the additive manufacturing process. Alternatively or additionally, a homogeneously behaving material is to be understood in this context as a liquid, a powder, a solid raw material or the like, the constituents of which behave in principle in the same way during the additive manufacturing process. i.e. exhibit a corresponding behaviour with regard to the curing and bonding process.

In particular, the homogeneously behaving material may be free of binders and other auxiliary agents which subsequently still have to be removed from the product in the course of the manufacturing process. In particular, no material having two different materials with different melting temperatures is used as raw material. Such inhomogeneous raw materials are used, for example, in indirect additive manufacturing processes in which only a green compact which can be subjected to low stress is produced in the additive manufacturing process and subsequently has to be subjected to a furnace sintering process. Instead, the component blank in the process according to the invention is characterized by the fact that it has the same total weight as the component resulting after the hot isostatic pressing process, that is, no removal of manufacturing aids such as binders or the like takes place. It is particularly noteworthy here that, due to the nature of the hot isostatic pressing process, an exertion of pressure is necessary for achieving the advantageous mechanical properties, which requires an insofar pressure-tight envelope of the component blank or a tight outer envelope formed in the component blank itself, and would thereby systematically prevent the removal of auxiliary materials such as binders from the component blank.

According to a further preferred embodiment, it is provided that a powder material is processed as the raw material, which powder material comprises powder particles of different particle size, wherein the particle size

lies between a lower powder particle size limit and an upper powder particle size limit and extends over a powder particle size bandwidth corresponding to the upper powder particle size limit minus the lower powder particle size limit,

and wherein a weight fraction of small powder particles having a particle size lying within a range of 10% to 20% of the total powder particle size range from the lower powder particle size limit is at least 20% by weight of the powder material,

and wherein a weight fraction of large powder particles having a particle size lying within a range of 10% to 20% of the total powder particle size range from the upper powder particle size limit is at least 20% by weight of the powder material.

According to this embodiment, powder material having a wide range of powder grain sizes is used as the raw material. Compared to powders usually used for additive manufacturing processes, which in particular have a specific grain size with a narrow spread of the grain size, on the one hand a low-cost raw material is thereby achieved. Depending on the flow behavior of the powder, the wide range of the grain size of the powder can lead to a favorable setting behavior of the powder and consequently achieve a high density. This is particularly advantageous in view of the fact that reduced shrinkage and reduced warpage occur in the subsequent HIP process if a high powder layer density has already been achieved. In this case, the powder can have a particle size distribution according to Gauss with a broad Gauss curve, but can also be composed by mixing in two powder particle fractions. Advantageously, with the process according to the invention there is no need to process powder mixtures with a narrow particle size range produced in high-quality and costly screening and sifting processes, since the subsequent HIP process of the process according to the invention achieves reliable compaction and consolidation of the component blank to form the loadable component.

In this context, it is particularly preferred that the lower powder particle size limit is 0, 10 or 20 μm and the upper powder particle size limit is 40, 50 or 75 μm. It has been shown that with powders having a grain size within the ranges defined in this way, sufficient resolution of geometric details of the component blank can be achieved in the additive manufacturing process and, at the same time, sufficient strength of the final component manufactured after the HIP process is achieved.
It is further preferred when a powder material is processed as the raw material, and the selective curing and joining of the raw material comprises the steps of:
a) applying a powder layer to a surface of a substrate plate or a prefabricated component by means of a powder application device,
b) Selective curing of the component regions to be cured in the applied powder layer and bonding of the component regions to be cured to the substrate plate underneath by the action of energy, in particular the action of electromagnetic radiation, to produce correspondingly cured component regions,
c) Application of a further powder layer on top of the previously applied powder layer by means of the powder application device,
d) selective curing of the component regions to be cured in the applied further powder layer and bonding of the component regions to be cured to the cured component regions of the underlying powder layer by the action of energy, in particular the action of electromagnetic radiation,
Multiple repetition of steps c) and d) to build up the component layer by layer.

According to this embodiment, a powder-based laser sintering or laser melting process is used as an additive manufacturing process. These processes are suitable for processing a variety of metallic raw materials into metallic components. This production of metallic components is improved by the densification and solidification in the HIP process according to the invention to a qualitatively reliable manufacturing process, with which components can be produced which can reliably and reproducibly withstand at most mechanical stresses.

In the powder-based additive manufacturing process, it is thereby particularly preferred that after at least one step of applying a powder layer in step a) and step c), preferably every second step or each step of applying a powder layer, a compaction of the powder layer is performed.

Such densification causes an additional increase in the powder density in the additive manufacturing process prior to curing and bonding of the respective powder layer. In particular, if, as described above, certain regions of the component blank are selectively not subjected to curing and bonding, but the raw material in these regions remains unchanged as powder material, such densification can have a beneficial effect on the subsequent shrinkage and warpage behavior in the HIP process.

In this context, it is particularly preferred if the compaction of the powder layer is preferably performed by means of a vibrating process of the powder layer. A vibrating process of the powder bed causes a settling of the powder particles, which results in a favorable compaction of the powder layer. In addition to a vibrating process, pressing processes, rolling processes or the like may be used to achieve the desired compaction.

According to a further preferred embodiment, in generating the component blank data set, determining the external geometry of the component blank comprises:
determining a product geometry and a reference structure disposed on the product geometry said reference structure being added as an outer surface to the product geometry,
determining a machining allowance volume that is attached to the product geometry in at least a partial region,
connecting the product geometry, the machining allowance volume and the reference structure to the outer geometry of the component blank, and in that, after the step of compacting and solidifying the component, a precision mechanical machining step is carried out, comprising:
defined positioning of the compacted and solidified component in a machining space of a material-removing maching device, the reference structure
being used as a measuring point or measuring surface for the defined positioning of the component in the machining space, or
serving as a damping spot or damping surface of a clamping device of the material-removing maching device,
removing material in the region of the machining allowance volume by means of a material-removing manufacturing method, in particular a cutting manufacturing method in the material-removing machining device,
and that the reference structure is removed after the precision mechanical machining step.

According to this embodiment, the HIP process is followed by a further machining step comprising a mechanical precision machining. Here, a material-removing machining process is used to produce a precise geometry of the component, which on the one hand can serve to produce certain surface qualities and on the other hand can serve to eliminate geometrical inaccuracies of the component caused by shrinkage and distortion/warpage after the HIP process. In order to be able to carry out this mechanical machining, a machining allowance is originally planned, i.e. the component is manufactured larger in those regions which are to be mechanically reworked than the later target geometry represents. The machining allowance can be provided as a whole, i.e. on all surfaces of the component, but preferably the machining allowance is provided only on predetermined, some surfaces of the component, in order to have a machining allowance only there where mechanical reworking is also necessary and provided. The mechanical finishing can be done for example by milling, grinding, eroding, turning. According to this further embodiment, a reference structure is provided on the component. This reference structure is used to be able to clamp the component in a defined manner in a processing machine for mechanical post-processing after removal from the HIP process, and consequently to be able to carry out automated mechanical post-processing. The reference structure can be used directly to clamp the component to it and thereby produce the predefined position of the component in the processing machine. Alternatively, the reference structure can also be used to perform an optical or scanning measurement and thereby establish a specific position of the component in the processing machine and then clamp it. In this case, clamping is not performed on the reference structure itself, but at another location on the component, but the reference structure is used as a measuring point or measuring surface or measuring body in order to determine the position and orientation of the component.

According to a further preferred embodiment, it is provided that during the compacting and solidifying of the component blank to form a component, the component blank is encased in a casing material, the casing material preferably being a metallic foil, such as a stainless steel foil. By wrapping the component with a foil, in particular a metallic foil, such as a stainless steel foil during the HIP process, undesirable reactions, structural changes of the material during the HIP process can be avoided, since the foil extends over the entire surface in a function as sacrificial anode of the process. Furthermore, in interaction with a certain atmosphere of an active gas in the furnace chamber, desired surface modifications of the component during the HIP process can be achieved by the stainless steel foil. On the one hand, such a cladding material can prevent diffusing substances from causing contamination of the furnace or other components pressed in the furnace at the same time. On the other hand, substances originating from the furnace atmosphere can be prevented from influencing the coated component. In particular, when pressing titanium components, a brittle phase of the titanium can be prevented from forming by means of a stainless steel foil coating.

Still further, it is preferred if in generating the component blank data set, determining the outer geometry of the component blank comprises:
Determining a target geometry,
determining a shrinkage volume which defines a shrinkage occurring during the compacting and solidifying of the component blank as a blank volume to be added to the component blank geometry, by which the component produced from the component blank after the compacting and solidifying has the target geometry, and/or
determining a distortion volume, which defines a distortion occurring during the selective curing and joining of the component blank and/or during the compacting and solidification of the component blank, as a blank volume to be added to the component blank geometry, by which the blank has the target geometry after the compacting and solidifying,
generating the component blank data set from the nominal geometry and a correction data set determined from the shrinkage volume and/or the distortion volume.

With this form of further development, the effects of shrinkage and warpage that occur during the additive manufacturing process itself, for example after a component has been detached from a substrate plate, and that occur during the subsequent HIP process due to the compaction achieved there, are already taken into account when creating the data set for the additive manufacturing process. This consideration can be made with the objective of additively manufacturing regions in which a particularly strong warpage or a particularly strong shrinkage is to be expected, and thereby partially or completely compensating for the subsequent geometric effects due to warpage and shrinkage. For the calculation of the geometric changes caused by shrinkage and warpage, experience values and algorithms can be used, which are based on mass accumulations of the component and computer-simulated thermal warpage effects during the additive manufacturing process, in order to achieve the desired compensation through the modified geometric specifications of the component blank data set.

It is particularly preferred if the correction data set is preferably determined by
creating a component in a first manufacturing step in which the component blank data set corresponds to a nominal geometry data set describing the nominal geometry of a product.
measuring the actual geometry of the component after compacting and solidifying the component produced in the first manufacturing step by means of an electronic measuring device and creating a three-dimensional actual geometry data set,
calculating a difference geometry data set from a comparison of the measured actual geometry of the component and the nominal geometry data set, and
calculating the correction data set from the difference geometry data set, wherein the difference geometry data set is preferably multiplied by a factor between 1 and 1.2, thereby determining the difference geometry data set.

According to this embodiment, the necessary correction is determined in an iterative process. For this purpose, a component is first manufactured in which the raw component data set corresponds to the desired nominal geometry of the component. The component produced in this way is subjected to a three-dimensional measurement after the HIP process. The geometry determined in this process is compared with the desired nominal geometry and determined here by the deviations from the nominal geometry resulting from warpage and shrinkage. These deviations are used as a correction data set, whereby shrinkage and warpage effects resulting from the compensation volume added or subtracted via the correction data set can be taken into account here by taking a factor into account, in order to ideally approximate the component produced in the next step with the component raw data set, which was corrected with the correction data set, to the nominal geometry.

Preferred embodiments of the invention are described with reference to the figures. Showing:

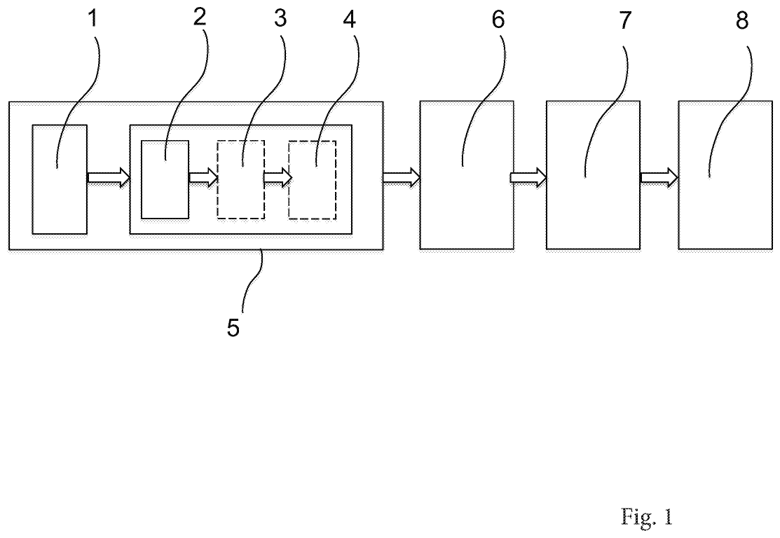

FIG. 1a schematic flow diagram of the process according to the invention,

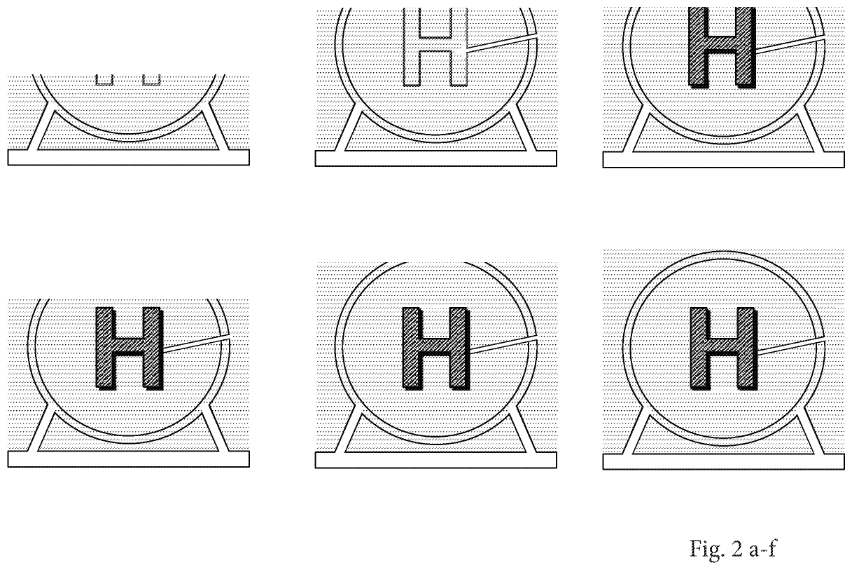

FIG. 2a-f The structure of a component according to the method according to the invention in a schematic representation.

The method according to the invention starts with the creation of a finished data set in step 1. Here, a data set, for example standardized in STL data format, is created on the basis of a desired target geometry of a component, which is done computer-aided by means of CAD programs. This three-dimensional data set is supplemented in step 1 with manufacturing parameters which define certain parameters of the manufacturing process for the component, which are to be applied in subsequent production in an additive manufacturing process. These manufacturing parameters can apply to the entire component, but can also be defined specifically for individual component regions and in this way define different manufacturing parameters for different component regions.

The creation of the manufacturing data set in step 1 further includes defining specific auxiliary structures, such as supports and the like, that are necessary or advantageous for the manufacturing process in certain additive manufacturing processes and that must subsequently be separated from the component.

Furthermore, step 1 defines the position in which the component is arranged in the production space of the device for additive manufacturing of the component. Particularly in the case of layer-by-layer additive manufacturing processes, attention must be paid to an advantageous alignment in order to achieve a high surface quality of certain surfaces.

Step 1 is followed as step 2 by the manufacture of the component in an additive manufacturing process. In this process, the component is built up automatically and produced layer by layer, point by point or line by line on the basis of the production data set. The production data set defines in each layer, which corresponds to a section through the component, the volume portions of the component lying in this section, corrected if necessary with geometric parameters which take into account shrinkage or warpage and, if necessary, plus production aids such as supports, reference structures or the like. These volume portions are cured in step 2 and bonded to previously cured volume portions of the component. This may be done, for example, by selectively scanning a powder layer, for example of a titanium alloy or titanium with a laser under the control of the manufacturing data set, or by masked exposure of a liquid layer of a photopolymerizing liquid, or by spot application of a curing material. The selective laser irradiation may be carried out in a controlled atmospheric environment, for example in an argon atmosphere.

Due to the only low density required for the component blank in the process according to the invention, the power of the laser used for selective irradiation may be lower than in such manufacturing processes aiming to achieve the required component strength already in the additive manufacturing process. For example, it is possible to selectively bond metallic powders to the component blank using a laser in the additive manufacturing process that has a power of less than 10 kw, or less than 5 kW, such as Yb fiber lasers and even excimer lasers with a power below 500 W can be used for metal powder processing.

Step 2 may be followed by a step 3 in which raw material is removed again from certain regions of the partially or completely built-up product in order to thereby create cavities. This step 3 may optionally be followed by a further step 4, in which cavities thus created are refilled with a raw material which is different from the original raw material. In this way, components can be produced which have regions with different raw materials.

In many additive manufacturing processes, in particular 3D printing processes, the product can also be built up directly in step 2 using different raw materials. Step 3 or step 4 can also be followed by a continuation of the additive manufacturing process in step 2 in order to further build up the product after the cavity has been created and, if necessary, filled.

The creation of the manufacturing data set and the manufacturing of the component in steps 2 and optionally 3 and 4 together form the additive manufacturing process 5 as a whole. This additive manufacturing process 5 is typically followed by a stress relief annealing, for example as a vacuum heat treatment, in a step 6. According to the invention, this step 6 is followed by a hot isostatic pressing process of the component in a step 7. This hot isostatic pressing process is carried out in a hot isostatic pressing furnace having a furnace chamber which can be pressurized to an elevated pressure and in which an elevated temperature can be set over a predetermined period of time. The temperature can be set as a constant temperature or as a temperature profile over time to set favorable heating and cooling phases for the product and to avoid unfavorable warping effects or microstructural changes. The furnace temperature is selected so that the component is heated to a sinterable temperature below the melting temperature of the material of the component. Typical values for carrying out the hot isostatic pressing process are an overpressure of 1000 bar, a temperature of 920° C. and a hot isostatic pressing time of 2 hours for the hot isostatic pressing of components that have previously been manufactured in an additive manufacturing process using a metallic raw material.

Optionally, the hot isostatic pressing in step 7 can be followed by mechanical finishing in step 8. Here, a mechanical machining process, for example a CAM-controlled milling process, is used to produce an exact geometry and surface quality of the component. The component can be machined on the basis of the CAD data used in step 1 for the creation of the manufacturing data set by creating the CAM manufacturing data for the mechanical machining from this CAD data and thereby correcting shrinkage and distortion effects caused by the previous steps.

FIGS. 2a-f show the sequence of manufacture of a component according to the method of the invention in an additive manufacturing process. The component is built up on a substrate plate 10, from which a plurality of supports 11, 12 extend, which serve as an auxiliary support structure to enable the component to be built up above the substrate plate without distortion. In individual cases, the component may also be directly connected to the substrate plate and must then subsequently be separated from the latter.

The supports 11, 12 also serve as a reference structure in the component manufactured according to the invention. On these supports, the component can be clamped in a mechanical machining process carried out after the hot isostatic pressing process and thereby placed and held in a predetermined, defined position for mechanical machining.

The component is built up in layers by applying a powder layer from above, curing the cross-sectional parts of the component that lie in this powder layer by the action of a laser and bonding them to parts of the component that lie underneath. In this process, the laser is selectively guided over the applied powder layer by computer control. In the laser focus, the powder material melts and bonds to the component section in this region. At the same time, the melted powder is bonded to an underlying portion of the component that lies in the previously selectively cured layer.

The component 20 has an outer envelope 21 which is circular in cross-section as shown. In this outer envelope region, the raw material is bonded in a gas-tight manner under the high energy effect of the laser beam.

The cladding region 21 encloses a core region 22, in which the raw material is bonded with reduced energy impact and therefore does not exhibit high mechanical stability. This reduced energy impact is achieved by guiding the laser with increased travel speed over the regions of this core region 22, thereby shortening the manufacturing process in terms of time. In principle, curing of the raw material by means of the laser could also be completely dispensed with in the core region, so that the raw material remains unchanged in the core region and is merely enclosed by the cladding region 21.

Within the core region, a second envelope region is built up which, like the first envelope region, is cured and bonded tightly by high energy impact. This second envelope region is formed in the cross-sectional contour of a double-T beam and serves to mechanically stiffen the component. A partial volume 24 of the core region is disposed within the second envelope region. This partial volume 24 is not subjected to curing and bonding, so that the raw material in the partial volume is unchanged in powder form.

A pressure equalization channel 30 connects the partial volume 24 with the environment outside the envelope region 21. Through this pressure equalization channel, the pressing pressure can be introduced into the partial volume in the subsequent hot isostatic pressing, so that the partial volume remains as a volume and is not compressed by the hot isostatic pressing process.

Shortly before the second enveloping region 23 is completely closed, in the step according to FIG. 2b the raw material arranged in the partial volume 2 is removed, for example by suctioning off the material. Instead of this raw material, another material is inserted into the partial volume, as can be seen in FIG. 2c. In principle, the filling of another raw material can also be dispensed with, so that the partial volume 24 remains as a cavity, filled with gas.

Continuing the manufacturing process in steps FIG. 2d to FIG. 2f, the second envelope region 23 is completely closed, thereby closing the hollow partial volume 24 or the partial volume 24 filled with the other raw material. Further, the core region is filled and the first envelope region 21 is also closed, whereby the component 20 has been completely manufactured in the additive manufacturing process.

The component thus produced is removed from the substrate plate by separating the supports 11, 12 from the substrate plate at their lower end and may then be subjected to a hot isostatic pressing (HIP) process. In this process, depending on whether the partial volume is hollow, or filled, the pressure equalization channel 30 may be maintained to supply the hollow volume to a pressure equalization of the hot isostatic pressing pressure, thereby maintaining it as a hollow space during the HIP process. The pressure equalization channel 30 may also be closed prior to the HIP operation to subject the partial volume to compression and solidification in the hot isostatic pressing operation, if a different feedstock material has been disposed therein.

1. A method for manufacturing components, comprising the steps:
producing a component blank in an additive manufacturing process, comprising:
determining, in an electronic planning process, component regions of the component blank which are to be cured and generating a component blank data set defining said component regions to be cured, and
dispensing a raw material and selectively curing and joining the raw material in said component regions to be cured based on the component blank data set of said component blank,
wherein the curing and joining of the raw material is performed using the component blank data set such that the component blank has a component blank density which is less than 99.5% of the density theoretically achievable with the raw material; and
compacting and solidifying the component blank to form a component in a hot isostatic pressing process, in which the component blank is heated in a furnace chamber to a temperature below the melting temperature of the raw material and is pressed by generating an overpressure in the furnace chamber by means of a furnace chamber pressure of at least 50 bar.

2. The method of claim 1, wherein
generating the component blank data set comprises the steps of
determining an outer geometry of the component blank;
defining an envelope region and a core region of the component blank, the envelope region enclosing the core region;
determining a first value of a first manufacturing parameter for the core region; and
determining a second value of said first manufacturing parameter for the envelope region, the second value being different from the first value,
and wherein the selective curing and joining of the raw material
is performed in the core region using the first value of the first manufacturing parameter and hereby generates a first density in the core region, and
is performed in the envelope region using the second value of the first manufacturing parameter and hereby generates a second density in the envelope region which is higher than the first density.

3. The method according to claim 1, wherein generating of the component blank dataset comprises
determining an outer geometry of the component blank;
defining a first envelope region and a core region of the component blank, the first envelope region partially or completely enclosing the core region;
defining at least one second envelope region enclosing a partial volume of the core region, the second envelope region lying within the first envelope region;
determining a first value of a first manufacturing parameter for the core region:
determining a second value of said first manufacturing parameter for the first envelope region, the second value being different from the first value;
determining a third value of said first manufacturing parameter for the partial volume, the third value preferably being the same as the first value, and
optionally determining a fourth value of said first manufacturing parameter for the second envelope region, the fourth value preferably being the same as the second value,
and wherein the selective curing and joining of the raw material
is performed in the core region using the first value of the first manufacturing parameter and generates a first density in the core region,
is performed in the first envelope region using the second value of the first manufacturing parameter and produces a second density in the first envelope region which is higher than the first density,
is performed in the partial volume using the third value of the first manufacturing parameter and produces a third density in the partial volume which is preferably identical to the first density, and
optionally is performed in the second envelope region using the fourth value of the first manufacturing parameter and produces a fourth density in the second envelope region that is preferably identical to the second density.

4. The method of claim 3, wherein
the third value of the first manufacturing parameter defines that
no raw material is placed in the partial volume during the additive manufacturing process, or
the raw material is placed in the partial volume during the additive manufacturing process and is removed again in a subsequent step, or
a different raw material is arranged in the partial volume than in the core region, or
the raw material is arranged in the partial volume during the additive manufacturing process, is removed again in a subsequent step, and the partial volume is filled with a second raw material which is different from the raw material in the core region, wherein preferably during or after the filling of the second raw material into the partial volume a compression of the second raw material takes place in the partial volume, in particular by means of a vibrating process of the second raw material.

5. The method according to claim 3, wherein
the component regions determined to be cured comprise a pressure equalization channel which extends from the first envelope region to the second envelope region and connects the partial volume to the environment of the component blank for fluid pressure transfer.

6. The method according to claim 2, wherein
said manufacturing parameter is a travel speed of a collimated electron beam and the first value is smaller than the second value or the third value is smaller than the fourth value, or
said manufacturing parameter is a radiation intensity of a collimated electron beam and the first value is greater than the second value or the third value is greater than the fourth value, or
said manufacturing parameter is a path spacing between two adjacent raster paths of a collimated electron beam and the first value is smaller than the second value, or the third value is smaller than the fourth value, or
said manufacturing parameter is a duration of an energy impact on the raw material leading to curing and bonding, and the first value is greater than the second value or the third value is greater than the fourth value, or
said manufacturing parameter is a layer thickness or a drop size when applying the raw material, and the first value is smaller than the second value, or the third value is smaller than the fourth value, or
said manufacturing parameter is a material definition and the first value, the second value and/or the third value each define different raw materials.

7. The method according to claim 1 wherein
generating of the component blank data set comprises
determining an outer geometry of the component blank
defining an envelope region and a core region of the component blank, the envelope region completely or partially enclosing the core region,
and wherein during the selective curing and joining of the raw material
the raw material in the envelope region undergoes processing leading to curing and joining, and
the raw material in the core region does not undergo any processing leading to curing and joining,
and wherein compacting and consolidating the component blank comprises
curing and joining of the raw material in the core region.

8. The method of claim 3, wherein when generating the blank data set
one of the two values selected from the first and the third value defines that the raw material does not undergo a processing leading to curing and joining, and
the other of the first and third values defines that the raw material undergoes processing leading to curing and joining, and
wherein during the selective curing and joining of the raw material
the raw material in the region which is cured and joined with one of the two values does not undergo any processing leading to curing and joining, and
the raw material in the region to be cured and joined with the other of the two values undergoes processing leading to curing and joining, and
wherein compacting and consolidating the component blank comprises
curing and joining of the raw material in the region that is cured and joined with one of the two values.

9. The method according to claim 1 wherein
the raw material behaves homogeneously during curing and joining, and/or
the raw material has such a temperature resistance, and the hot isostatic pressing process is carried out with such process parameters that the weight of the component blank does not change during the hot isostatic pressing process.

10. The method according to claim 1 wherein a powder material is processed as the raw material, wherein the powder material comprises powder particles of different particle size, wherein a particle size
lies between a lower powder particle size limit and an upper powder particle size limit and extends over a powder particle size bandwidth corresponding to the upper powder particle size limit minus the lower powder particle size limit,
and wherein a weight fraction of small powder particles having a particle size lying within a range of 10% to 20% of the total powder particle size range from the lower powder particle size limit is at least 20% by weight of the powder material,
and wherein a weight fraction of large powder particles having a particle size lying within a range of 10% to 20% of the total powder particle size range from the upper powder particle size limit is at least 20% by weight of the powder material.

11. The method according to claim 1 wherein a powder material is processed as the raw material, and the selective curing and joining of the raw material comprises the steps of
a) applying a powder layer to a surface of a substrate plate or a prefabricated component by means of a powder application device;
b) selective curing of the component regions to be cured in the applied powder layer and bonding of the component regions to be cured to the substrate plate underneath by the action of energy, in particular the action of electromagnetic radiation, to produce correspondingly cured component regions;
c) applying of a further powder layer on top of the previously applied powder layer by means of the powder application device; and
d) selective curing of the component regions to be cured in the applied further powder layer and bonding of the component regions to be cured to the cured component regions of the underlying powder layer by action of energy,
wherein multiple repeats of steps c) and d) to build up the component layer by layer.

12. The method according to claim 1 wherein in generating the component blank data set,
determining the external geometry of the component blank comprises determining a product geometry and a reference structure disposed on the product geometry said reference structure being added as an outer surface to the product geometry,
determining a machining allowance volume that is attached to the product geometry in at least a partial region,
connecting the product geometry, the machining allowance volume and the reference structure to the outer geometry of the component blank,
and wherein after the step of compacting and solidifying the component, a precision mechanical machining step is carried out, comprising
defined positioning of the compacted and solidified component in a machining space of a material-removing maching device, the reference structure
being used as a measuring point or measuring surface for the defined positioning of the component in the machining space, or
serving as a clamping spot or clamping surface of a clamping device of the material-removing maching device,
removing material in the region of the machining allowance volume by means of a material-removing manufacturing method, in particular a cutting manufacturing method in the material-removing machining device,
and wherein the reference structure is removed after the precision mechanical machining step.

13. The method according to claim 1 wherein during the compacting and solidifying of the component blank to form a component, the component blank is encased in a casing material, the casing material preferably being a metallic foil, such as a stainless steel foil.

14. The method according to claim 1 wherein in generating the component blank data set, determining the outer geometry of the component blank comprises
determining a target geometry
determining a shrinkage volume which defines a shrinkage occurring during the compacting and solidifying of the component blank as a blank volume to be added to the component blank geometry, by which the component produced from the component blank after the compacting and solidifying has the target geometry, and/or
determining a distortion volume, which defines a distortion occurring during the selective curing and joining of the component blank and/or during the compacting and solidification of the component blank, as a blank volume to be added to the component blank geometry, by which the blank has the target geometry after the compacting and solidifying,
one or more of the nominal geometry, a correction data set determined from the shrinkage volume, and/or the distortion volume is used to generate the component blank data set,
wherein the correction data set is preferably determined by
creating a component in a first manufacturing step in which the component blank data set corresponds to a nominal geometry data set describing the nominal geometry of a product,
measuring the actual geometry of the component after compacting and solidifying the component produced in the first manufacturing step by means of an electronic measuring device and creating a three-dimensional actual geometry data set,
calculating a difference geometry data set from a comparison of the measured actual geometry of the component and the nominal geometry data set, and
calculating the correction data set from the difference geometry data set, wherein the difference geometry data set is preferably multiplied by a factor between 1 and 1.2, thereby determining the difference geometry data set.

15. The method according to claim 1 wherein during compacting and solidifying according the furnace chamber is charged with
at least one raw component which has been produced according to one of determining and/or dispensing steps and which, in order to achieve compaction and solidification, requires a hot isostatic pressing operation with a first set of parameters comprising a first pressing pressure, a first pressing temperature and a first pressing duration, and
wherein at least one component which has been produced by a casting process and which, in order to achieve compaction and solidification, requires a hot isostatic pressing operation with a second set of parameters comprising a second pressing pressure, a second pressing temperature and a second pressing duration,
and wherein the compacting and solidifying is performed with a third set of parameters comprising as the pressing pressure the higher one of the first and second pressing pressures, as the pressing temperature the higher one of the first and second pressing temperatures, and as the pressing time the longer one of the first and second pressing times.

16. The method of claim 9 wherein the raw material is a powder material which consists of powder particles, wherein all the powder particles having the same melting temperature

17. The method of claim 9 wherein the lower powder particle size limit is 0, 10 or 20 □m and the upper powder particle size limit is 40, 50 or 75 □□m.

18. The method of claim 11 wherein the action of energy is electromagnetic radiation.

19. The method of claim 11 wherein
after at least one step of applying a powder layer in step a) and step c), a compaction of the powder layer is performed after each step or every other step of applying the powder layer.

20. The method of claim 19 wherein compaction of the powder layer is performed by vibration.
